(19) United States
(12) Patent Application Publication
(10) Pub. No.: US 2008/0256227 A1
(43) Pub. Date: Oct. 16, 2008

(54) METHOD AND PRODUCT FOR CONTROLLING LABORATORY EQUIPMENT

(75) Inventor: Cosmas G. MALIN, Mauren (LI)

Correspondence Address: GREENBLUM & BERNSTEIN, P.L.C., 1950 ROLAND CLARKE PLACE, RESTON, VA, 20191, US

(73) Assignee: LICONIC AG, Mauren (LI)

(21) Appl. No.: 12/101,551

(22) Filed: Apr. 11, 2008

(30) Foreign Application Priority Data
Apr. 13, 2007 (EP) 07 405 120.2

(51) Int. Cl. G06F 9/54; G06F 15/173; G06F 12/02

(52) U.S. Cl. 709/223; 719/315; 711/173; 711/E12.002

(57) ABSTRACT

Method, apparatus and product for controlling an automated storage system for laboratory objects. The storage system includes a plurality of storage locations for receiving the laboratory objects. The method includes defining users having access to the storage system and storing the users in a database, defining partitions, with each partition comprising at least part of the storage locations, and storing the partitions in the database, and storing properties for each of the partitions in the database.

### CROSS-REFERENCE TO RELATED APPLICATIONS

The present application claims the priority of European Patent Application No. 07 405 120.2, filed Apr. 13, 2007, the disclosure of which is incorporated herein by reference in its entirety.

### BACKGROUND OF THE INVENTION

1. Field of the Invention

The invention relates to a method and apparatus for controlling laboratory equipment, in particular for controlling an automated storage system for laboratory objects, such as microwell plates. The invention also relates to a computer comprising elements for carrying out the inventive method.

2. Discussion of Background Information

Laboratory equipment typically comprises specialized hardware for controlling, handling, storing or analyzing laboratory objects, such as chemical or biological samples in suitable containers. Other laboratory equipment is used for controlling, measuring or analyzing processes or samples in a laboratory.

Various solutions for controlling such laboratory equipment are known. Typically, the equipment is connected to a host computer, and software running on the host computer is used to control the equipment. The equipment is connected to the computer by a hardware interface, such as a serial port. For improving the modularity of the software, the manufacturer of the equipment can provide a library of code that provides a well-defined application program interface (API) for controlling the equipment, thereby shielding the higher level components of the software from the intricacies of the equipment interface. This scheme is particularly useful if the higher level components of the software are written by an entity other than the equipment's manufacturer.

### SUMMARY OF THE INVENTION

Accordingly, the present invention is provides a system of the type described above with even better modularity.

In a first aspect of the invention, a method is provided for controlling laboratory equipment, in particular an automated storage system for laboratory objects, with a host computer connected to the laboratory equipment via a hardware interface. The method includes running, on the host computer, a software service listening to messages on a TCP/IP port of the host computer, and processing, by the software service, a command received through the TCP/IP port and controlling the laboratory equipment through the hardware interface in accordance with the command.

Accordingly, a software service listening to incoming messages on a TCP/IP port is provided on the host computer. The incoming messages are processed by the software service and are used to control the laboratory equipment through the hardware interface.

The advantage of this scheme is that the software service can be controlled through an extremely well defined interface, namely a TCP/IP port. All presently used major operating systems and most programming environments have standardized APIs for accessing a TCP/IP port, which makes it possible to control the laboratory equipment from any programming language and computer.

It must be noted that this is a highly unconventional application of a TCP/IP port. Typically, TCP/IP ports are used for providing remote computers with a device to control a given computer. In the present application, the TCP/IP port is used for providing remote computers as well as processes running on the host computer with a device to control equipment that is not part of the host computer. A more straightforward approach would be to install a TCP/IP interface on the laboratory equipment and then talk to a TCP/IP port of the equipment directly. This, however, would require complex hard- and software on the laboratory equipment.

In a second aspect of the invention, an efficient storage of laboratory objects is provided in an automated storage system.

In this second aspect, a method for controlling an automated storage system for laboratory objects is provided. The storage system comprises a plurality of storage locations for receiving the laboratory objects. The method includes defining users having access to the storage system and storing the users in a database, defining partitions, with each partition comprising at least part of the storage locations, and storing the partitions in the database, and storing properties for each of the partitions in the database.

In yet another aspect, an efficient storage of laboratory objects is provided in an automated storage system.

In this third aspect, a method for controlling an automated storage system for laboratory objects is provided. The storage system comprises a plurality of storage locations for receiving the laboratory objects. The method includes a defragmentation by rearranging the objects automatically within the storage locations for storing them in physically contiguous manner.

The present invention is directed to a method for controlling laboratory equipment with a host computer connected to the laboratory equipment via a hardware interface. The method includes running, on the host computer, a software service listening to messages on a TCP/IP port of the host computer, processing, by the software service, a command received through the TCP/IP port, and controlling the laboratory equipment through the hardware interface in accordance with the command.

According to a feature of the invention, the equipment can include an automated storage system for laboratory objects.

In accordance with another feature of the instant invention, the laboratory equipment may be remote from the host computer.

The laboratory equipment can be connected to the host computer through a serial interface, and the serial interface may include at least one of a USB, RS-232 and Ethernet interface.

According to still another feature of the present invention, the processing of the command can include translating the command into a series of instructions and passing the instructions to the laboratory equipment.

In accordance with another feature, the command may be encoded as a string of characters.

According to a further feature of the instant invention, the method can include sending an answer in reply to the command. The answer may be sent through the TCP/IP port. Further, the answer can be encoded as a string of characters.

The method can also include running a client application on the host computer. The client application may communicate with the software service through TCP/IP protocol.

Moreover, the software service can include a dynamically linkable library providing an API for controlling the laboratory equipment without sending commands through the TCP/IP port. The software service may include an executable control application in addition to the dynamically linkable library, which executable control application binds itself to the TCP/IP port and forwards the commands from the TCP/IP port to the dynamically linkable library.

In accordance with still another feature of the invention, communication through the TCP/IP port may be carried out under telnet protocol.

The software service may issue an event message when a predefined event occurs on the laboratory equipment. The software service can monitor the laboratory equipment for the predefined event and/or wherein the event message is sent through the TCP/IP port.

The invention is directed to a method for controlling an automated storage system for laboratory objects. The storage system includes a plurality of storage locations for receiving the laboratory objects. The method includes defining users having access to the storage system and storing the users in a database, defining partitions, with each partition comprising at least part of the storage locations, and storing the partitions in the database, and storing properties for each of the partitions in the database.

According to a feature of the invention, the properties may include a list of users having access rights to the partition. The method can further include defining at least one common partition where all users have access rights.

The invention is directed to a method for controlling an automated storage system for laboratory objects. The storage system includes a plurality of storage locations for receiving the laboratory objects. The method includes defragmenting the objects automatically within the storage locations by rearranging and storing the objects in a physically contiguous manner.

In accordance with a feature of the invention, the storage locations can be arranged in a plurality of storage towers and the objects may be rearranged to free at least one storage tower from the objects.

In accordance with still yet another feature of the present invention, the method may also include accessing a database with inventory data describing used and unused storage locations.

The invention is directed to an apparatus for controlling laboratory equipment. The apparatus includes a host computer having at least a hardware interface and a TCP/IP port, in which the laboratory equipment is connected to the host computer via the hardware interface. First code is recorded on a tangible medium that is executable on the host computer for listening to messages on the TCP/IP port, second code is recorded on a tangible medium that is executable by the first code to process a command received through the TCP/IP port, and a controller is structured and arranged to control the laboratory equipment through the hardware interface in accordance with the processed command.

The invention is directed to a system that includes a host computer having at least a hardware interface and a TCP/IP port, in which laboratory equipment is coupled to the host computer through the hardware interface. The system also includes a server having a database containing data associated with one or more instructions for implementing control of laboratory equipment, and at least one of a hardware and software component for processing a command received on the TCP/IP port and for controlling the laboratory equipment in accordance with the command.

The invention is directed to a computer program product comprising a computer usable medium having readable program code embodied in the medium and including at least one component to process commands received on a TCP/IP port of a host computer coupled to laboratory equipment through a hardware interface, and control the laboratory equipment based upon the processed commands.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a block diagram of the most important components of the system;

FIG. 2 is a schematic representation of a user interface for maintaining and organizing the storage locations; and

FIG. 3 is an illustration of the defragmentation of the storage locations.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

Before describing the system in detail, the following definitions are given:
The term “dynamically linkable library” (or “dynamically linked library”) or DLL refers to a library comprising code and a description for calling the code. It is in a format that allows the code to be read into executable memory by the operating system and to be called by a thread running on the host computer. Typical examples of dynamically linkable libraries are the so-called DLL files under the Windows operating system, but other file formats can be used as well.
A TCP/IP port is a specific port under the TCP/IP protocol. Such a port is fully identified on a local network by its IP-address and port number.
Encoding data (such as commands or answers) “as a string of characters” is to be understood as encoding the data as a series of characters, e.g., using ACSII or UTF8 coding. Typically, each character has 8 or 16 bits, albeit 8 bit encoding is preferred because it does not suffer from endian-related problems in cross-platform communication. For example, numbers are encoded as a series of numeric characters, e.g., ‘3’, ‘2’, for the number 32, and not in binary format (such as hex 0×20 for the number 32).

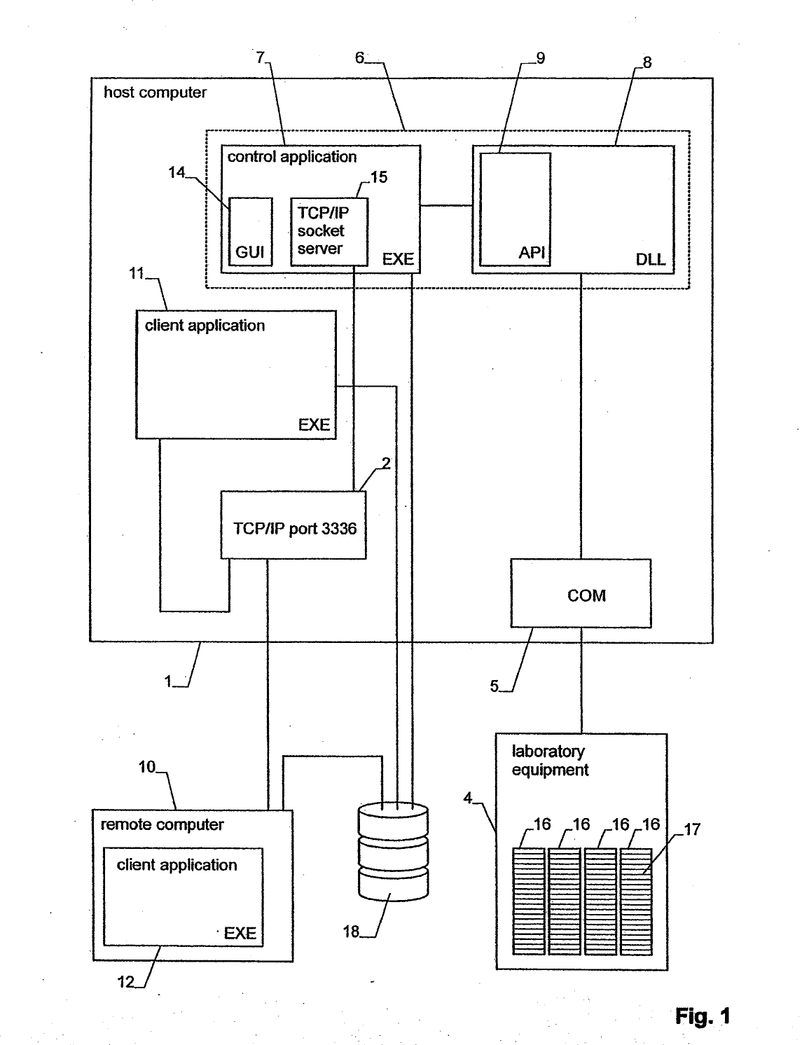

The system shown in FIG. 1 comprises a host computer 1, which is typically a fully equipped computer with a conventional operating system and hardware, including keyboard and display.

In particular, host computer 1 is equipped with a TCP/IP interface having a plurality of ports. As mentioned, at least one port is used by the system. In FIG. 1, this port is designated by reference number 2 and, by way of example, carries port number 3336, although any other unused and non-reserved port number can be used as well.

Furthermore, host computer 1 has an interface for communicating with external laboratory equipment 4. In the example of FIG. 1, a communication interface 5 is used for that purpose. Communication interface 5 is advantageously a serial interface, e.g., an RS-232, USB or Ethernet port. It must be noted, however, that any other type of interface can be used for connecting host computer 1 to laboratory equipment 4, such as an Ethernet connection (using a port other than the one indicated by reference number 2), a wireless connection, a Firewire connection, a parallel printer port, etc.

Typically, laboratory equipment 4 will be remote from host computer 1, e.g., it will be located outside the housing of host computer 1 and be connected thereto by cabling or a wireless connection.

Laboratory equipment 4 is advantageously an automated storage system for laboratory objects in a climate controlled chamber, such as e.g., described in WO 02/059251, and comprises a plurality of storage locations for microwell plates (microtiter plates) and an automated transport device for accessing the plates in the storage locations, e.g., for moving the plates between storage locations, or for transferring the plates between the storage locations and an external system. The equipment can further be provided with a control system and sensors for controlling the climate (temperature and atmospheric composition) in the cabinet as well as with a bar code reader for reading bar codes attached to the plates. The equipment can be controlled through interface 5 by a set of low level instructions.

In the example of FIG. 1, the storage locations are formed by a plurality of storage towers 16, e.g., as disclosed in WO 02/059251. Each storage tower holds a plurality of storage locations 17 vertically above each other and each storage location can receive, e.g., a microtiter plate or microwell plate or a holder with a plurality of sample locations. Each sample location can be adapted to receive one sample, such as a tube.

The purpose of the present invention is to provide a way to access the functions of laboratory equipment 4. To achieve this, a software service 6 is installed on host computer 1. In the embodiment of FIG. 1, software service 6 comprises two parts, namely an executable control application 7 and a dynamically linkable library (DLL) 8.

When control application 7 is started, it binds a TCP/IP socket server 15 to TCP/IP port 3336 (or any other port as defined by a suitable parameter accessible by control application 7) and listens to incoming messages. It also links itself to DLL 8. TCP/IP socket server 15 is running asynchronously and is able to handle multiple client applications and command concurrently.

DLL 8 comprises code for controlling laboratory equipment 4 through interface 5. This code is available to processes running on host computer 1 by an application programming interface (API) 9 defining a set of high level functions. The code in DLL 8 translates the commands received through its API 9 to a series of low level instructions understood by laboratory equipment 4.

As mentioned, one primary purpose of software service 6 is to listen to commands arriving at TCP/IP port 3336 and to control laboratory equipment 4 in accordance with these instructions. This can be used by processes running on host computer 1 or on a remote computer 10 for controlling laboratory equipment 4.

In the embodiment of FIG. 1, two such processes are illustrated as client applications 11 and 12, in which client application can be running on host computer 1 and client application 12 can be running on a remote computer 10. As shown, remote computer 10 can be connected via TCP/IP to host computer 1.

To control laboratory equipment 4, client application 11 or 12 sends a command to TCP/IP port 3336, which is received by control application 7. Control application 7 translates the received command to one or more API calls of DLL 8 and calls the same. Advantageously, there is one API function provided by DLL 8 for each command understood by control application 7.

Typically, each command incoming through TCP/IP port 3336 will be answered. The answer may comprise a simple status message indicating if the command was executed successfully, or it can also contain a reply received from laboratory equipment 4, such as the current temperature or other atmospheric conditions within the climate controlled cabinet.

Advantageously, the answer is sent through TCP/IP port 3336 during the session established by client application 11 or 12, albeit other means of communication from software service 6 to the client application 11, 12 can be used as well.

One advantage of using a TCP/IP port is the fact that an inherently network-enabled solution is achieved. The port can not only be accessed from host computer 1, but from remote computers as well.

Another important advantage of using a TCP/IP port is the fact that such a port is well suited for exchanging character strings, which allows to encode all commands and answers as strings of characters. In contrast to a binary encoding, an encoding as strings of characters is well portable between different applications and platforms.

Advantageously, the simple “telnet” protocol can be used for data exchange through the TCP/IP port, albeit other protocols can be used as well, such as “ssh” if a secure and/or authenticated transmission is required.

In the following, some examples of command and their processing are described.

### EXAMPLE 1

The command ‘ACTIVATE(id)’ (where id is a name or number, such as ‘10’) sent to TCIP/IP port 3336 is used to tell software service 6 to open communication with a laboratory system having the given identifier name or number id. Using an identifier number allows to connect several items or different sections of laboratory equipment 4 to host computer 1, each of which is addressed by a unique identifier. Asynchronous TCP/IP socket server 15 can run the commands for the different items of equipment concurrently.

When control application 7 e.g., receives the ‘ACTIVATE(10)’ command, it converts the parameter 10 to a binary number and calls a function defined as

int Activate(int id);

in the API of DLL 8, passing the binary number 10 in parameter id. When this function is called, DLL 8 translates it into a series of low level instructions for the laboratory equipment 4 that has the identifier ‘10’. For example, DLL 8 can issue an instruction for resetting the equipment's hardware, it can then wait for a confirmation signal from the equipment that the resetting operation has been completed. Then, it issues an instruction to the equipment to return its status. When the status is retuned by the equipment, it is returned by function Activate as a binary number to control application 7, which translates this number to a string and returns it through TCP/IP port 3336 to client application 11 or 12.

### EXAMPLE 2

The command ‘MOVEPLATE(srcID, srcPos, dstID, dstPos)’ (with srcID, srcPos, dstID, dstPos being numbers, such as ‘10, 3, 10, 7’) sent to TCIP/IP port 3336 is used to tell software service 6 to move a laboratory object (a “plate”) from one location to another. The parameters srcID and srcPos define the source location where the plate is at the present time, while the parameters dstID and dstPos define where the plate has to go.

When control application 7 receives, e.g., the ‘MOVEPLATE (10, 3, 10, 7)’ command, it may convert the parameters 10, 3, 10, 7 to a binary numbers and call a function defined as

int Move(int srcID, int srcPos, int dstID, int dstpos);

in the API of DLL 8, passing the binary numbers 10, 3, 10, 7 as its arguments. DLL 8 may again translate the command into a series of low level instructions for the laboratory equipment for moving the equipment's transport device to the correct source location, taking up the plate, moving the plate to the correct destination position, and putting it down. The function can again return a status code, which control application 7 translates to a string and returns through TCP/IP port 3336 to client application 11 or 12.

Other examples for commands that can be sent to TCP/IP port 3336 comprise, e.g.,:
A command for activating/deactivating a shaker located in equipment 4 and for defining its shaking speed.
A command for locking/unlocking a door of equipment 4.
A command for operating a barcode reader in equipment 4 in order to read a barcode on one of the microwell plates stored therein. The answer returned by this command is a string representation of the barcode data.
A command for controlling the climate in equipment 4 as well as a command for reading out the values of environmental sensors in equipment 4.

The functionality of control application 7 can be restricted to simply passing messages and answers the between TCP/IP port and DLL 8. However, control application 7 can also provide further functionality, such as a user interface 14 for controlling and/or monitoring the laboratory equipment manually. Such a user interface 14 can provide, e.g., functions for displaying the plates stored in a storage system and for manipulating them,, e.g., using a “drag and drop” interface. Control application 7 can further offer a programming environment for programming sequences of operations to be carried out on the equipment, and/or for inventory tracking of the objects stored within the equipment.

Software service 6 will, in general, have to access a variety of predefined settings, such as the port number of the TCP/IP port to be used, hardware interface 5 to be used for connecting to laboratory equipment 4, the type of laboratory equipment, etc. These settings can e.g., be stored in configuration files on host computer 1 and/or they can be accessed and changed through a user interface provided by control application 7.

It must be noted that any application run on host computer 1 can theoretically control DLL 8 either by sending commands through the TCP/IP port or by linking to the DLL directly. An access through the TCP/IP port will provide better insulation and modularity, while a direct linking to the DLL may allow additional functionality and/or improved throughput.

In the embodiment shown so far, software service 6 was implemented by control application 7 and DLL 8. It must be noted, though, that the same or an equivalent functionality can also be achieved by different configurations. For example, control application 7 can also include the functionality of DLL 8. Alternatively, a single, faceless background task or driver software can be bound to the TCP/IP port as well as to hardware interface 5 as provide the functionality of control application 7 (without user interface) and DLL 8, while the user interface could, if desired, be provided by client application 11.

The architecture described here allows several client applications 11, 12 to access the laboratory equipment 4 at the same time, e.g., one for displaying the status of the equipment and another one for controlling the flow of laboratory objects within it. Since the TCP/IP standard allows concurrent access from a plurality of clients to the same port, such a scheme can be implemented easily.

The software in laboratory equipment 4 can be simple since any complex operations can be carried out by software service 6. In particular, as mentioned, software service 6 can generate complex series of instructions for the equipment from a single command message. Also, software service 6 can contain safety checks for preventing illegal operations on equipment 4.

Client applications 11 and 12 can be specialized applications for controlling laboratory equipment. Alternatively, simple “telnet” terminal clients can be used as well for manually entering commands. No web browser is required. However, other protocols, such as http, can be used as well.

Software service 6 can also send messages to client applications 11 and/or 12 not in reply to a command message, but in reply to an event generated either by software service 6 or by laboratory equipment 4. In particular, software service 6 can be instructed to monitor laboratory equipment 4 and issue an event message whenever a predefined event occurs. For example, software service 6 can monitor the temperature in a climate controlled cabinet of equipment 4 and issue an event message when the temperature falls outside a given range. The event message can be sent to the appropriate client software 11 or 12 e.g., through an existing TCP/IP socket or in alternate manners.

Database:

The system can also comprise a database as indicated by reference number 18 in FIG. 1. This may be, e.g., an sql database on a database server remote from host computer 1. Database 18 can, however, also be formed by other storage devices, such as XML-files or CSV-files stored on host computer 1.

Database 18 can be accessed by, e.g.,:

1) control application 7 on host computer 1 for storing:

(a) inventory data of the laboratory equipment, e.g., indicating the items stored in storage locations 17;

(b) user data describing the users authorized to access the system; and

(c) virtual partitions formed from the storage locations and the properties of these partitions;

2) client application 11 on host computer 1 and/or remote computer 10, e.g., for retrieving the user data for a user logging into the system, such as GUI settings and access rights for that user or any other data mentioned above.

Database 8 can also be used, e.g., for logging, history storage (such as climate history of an attached equipment), searching, and physical description of hardware.

More information regarding the data to be stored in database 18 are given in the following sections.

Control application 7 and/or client application 11 can further be provided with functionality for importing/exporting data into/from database 18 from/into other data formats, such as csv files.

Storage organization:

As mentioned, database 18 can be used to store inventory data, i.e., data describing the contents of the individual storage locations and/or sample locations in laboratory equipment 4.

Database 18 can further be used for defining partitions. Each partition is a set comprising at least part of the storage locations available in one or more pieces of equipment 4 controlled by the present system. Advantageously, a given storage location is not attributed to more than one partition.

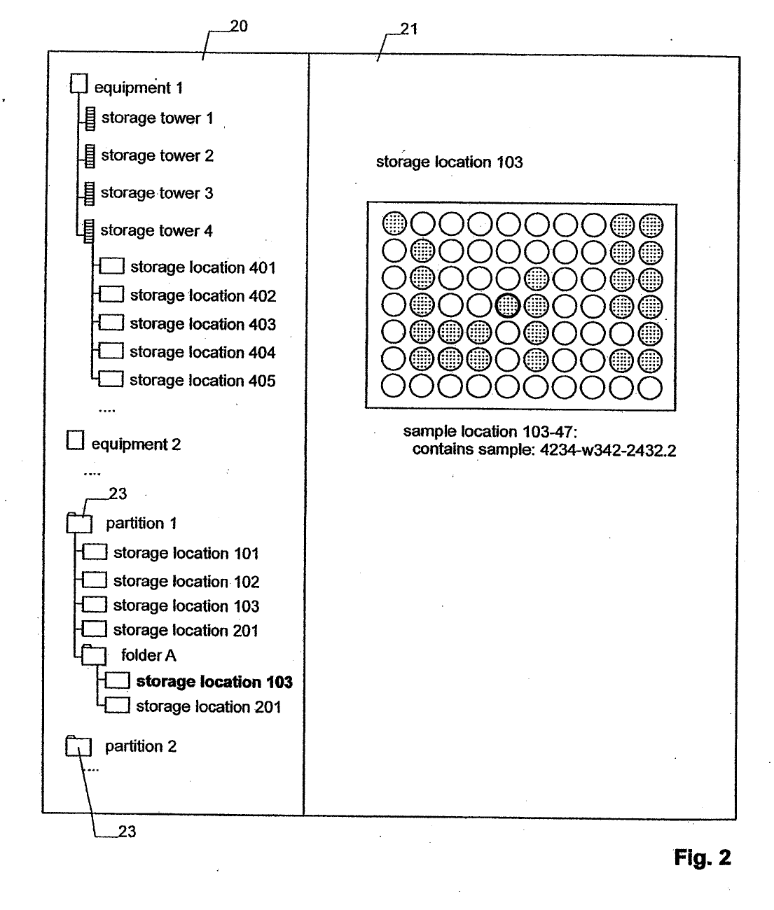

This is illustrated in FIG. 2, which is a schematic representation of part of the user interface of control application 7. In the left hand part 20 of the interface, a hierarchical representation of the physical and logical resources can be seen. In the right hand part 21 of the interface, additional information about the object selected in the left hand part is shown. This type of user interface is familiar to the user of modem GUI-based operating systems.

The upper section of left hand part 20 shows physical resources, namely the equipment controlled by the system. In the illustrated embodiment, the system controls two pieces of laboratory equipment called “equipment 1” and “equipment 2”, each formed by, e.g., a climate controlled cabinet holding storage towers 16.

By double-clicking a piece of equipment in the left hand part, the individual items within the equipment become visible, such as storage towers 16 within a climate controlled cabinet. By double-clicking an individual item, the contents of the item become visible, such as individual storage locations 17 of a storage tower 16.

Left hand part 20 further shows partitions 23. Partitions 23 can be defined by, e.g., the administrator user of the system. Each partition can include, e.g., a plurality of storage locations 17, and each partition can be further subdivided by folders, which can again comprise one or more other folders and/or one or more storage locations 17.

Furthermore, each partition has properties that define, e.g., how it is to be used. The properties can define, e.g.,:
(a) A list of the users that have access rights to the partition and the operations these users can perform thereon. For example, each user of the system can access one or a few partitions, while the remaining partitions remain inaccessible to him. Within the partitions that the user has access to, he can manipulate laboratory items by, e.g., removing them, adding them or moving them.
(b) The name of a partition.
(c) The physical format of the objects that can be received in the storage locations of the partition.
(d) A project the partition is attributed to.
(e) etc.

For example, each normal user can have one private partition for his own use, and, in addition, at least one common partition can be defined where all users have access. The common partitions allow the users to exchange laboratory items and/or e.g., to deposit used objects to be recycled or to obtain new, empty objects.

Partitions also allow the users to store their plates, e.g., by project, with a partition attributed to each project. A user can also list the objects stored in each partition.

It must be noted that the organization of partitions is completely independent of the physical organization of the equipment. A partition may extend, e.g., over only parts of some storage towers, or several storage towers, or even several storage cabinets. The administrator user can, e.g., dynamically reassign how the partitions are mapped to the physical resources of the system in a manner that is transparent to the user.

The right hand section of the interface of FIG. 2 shows detailed information about the item selected in the left hand section. In the example shown, the user has selected the storage location of a holder for sample tubes in the left hand section, and a physical representation of the holder therein with its used an unused sample locations is shown in the right hand section. The user can select a sample location in the holder, and information about the selected sample tube, which has been obtained, e.g., by the system by reading a barcode on the tube while storing the same, is displayed.

Defragmentation:

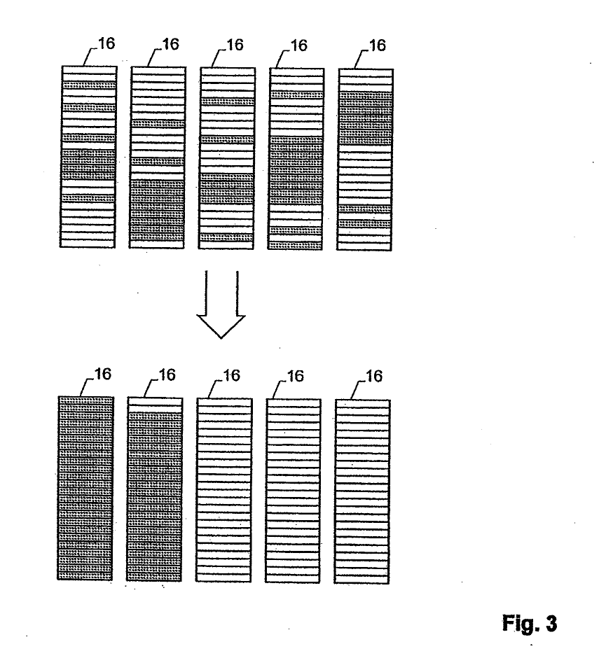

In the course of normal use of the storage system, defragmentation can occur. Defragmentation within the context of the present invention is illustrated in the upper half of FIG. 3, which shows, by way of example, five storage towers 16 with their storage positions 17 being either full storage positions represented by a dotted pattern or empty storage positions shown in white (without a pattern). As can be seen, the objects are distributed over the storage positions in a random or at least physically non-contiguous manner. Such a distribution binds a large number of storage towers, thereby making it difficult to replace storage towers, e.g., for cleaning. In addition, this distribution can lead to an increase of access time.

Therefore, the present system allows to automatically “defragment” the storage system by rearranging the objects within the storage locations in order to store them in physically contiguous manner. This is depicted in the lower half of FIG. 3.

By rearranging the objects in suitable manner, it becomes possible to free, e.g., at least one of the storage towers from the objects.

Defragmentation can be carried out automatically. For this purpose, the system accesses the inventory data in database 18, which describes the used and unused storage locations, and then determines gaps between the used storage locations. It then moves some of the stored objects to eliminate these gaps.

Defragmentation can be carried out automatically, i.e., without the user indicating in detail where the individual objects have to go. Defragmentation is either initiated manually by a user or automatically (e.g., at certain intervals).

In the example above, defragmentation has been carried out by rearranging the laboratory objects within their storage positions. For example, if the objects are microtiter plates, the plates can be moved between the storage positions 17 of the storage towers 16.

Defragmentation can, however, also be carried out on a sample basis. If, for example, the objects are sample tubes held in holders and the system is able to move the sample tubes between the different storage locations of different holders, the sample tubes can be rearranged to minimize the number of holders used.

While there are shown and described presently preferred embodiments of the invention, it is to be distinctly understood that the invention is not limited thereto but may be otherwise variously embodied and practiced within the scope of the following claims.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A method for controlling laboratory equipment with a host computer connected to the laboratory equipment via a hardware interface, the method comprising:
running, on the host computer, a software service listening to messages on a TCP/IP port of the host computer;
processing, by the software service, a command received through the TCP/IP port; and
controlling the laboratory equipment through the hardware interface in accordance with the command.

2. The method in accordance with claim 1, wherein the equipment comprises an automated storage system for laboratory objects.

3. The method in accordance with claim 1, wherein the laboratory equipment is remote to the host computer.

4. The method in accordance with claim 1, wherein the laboratory equipment is connected to the host computer through a serial interface.

5. The method in accordance with claim 4, wherein the serial interface comprises at least one of a USB, RS-232 and Ethernet interface.

6. The method in accordance with claim 1, wherein the processing of the command comprises:
translating the command into a series of instructions; and
passing the instructions to the laboratory equipment.

7. The method in accordance with claim 1, wherein the command is encoded as a string of characters.

8. The method in accordance with claim 1, further comprising sending an answer in reply to the command, wherein the answer is sent through the TCP/IP port.

9. The method in accordance with claim 8, wherein the answer is encoded as a string of characters.

10. The method in accordance with claim 1, further comprising running a client application on the host computer, wherein the client application communicates with the software service through TCP/IP protocol.

11. The method in accordance with claim 1, wherein the software service comprises a dynamically linkable library providing an API for controlling the laboratory equipment without sending commands through the TCP/IP port.

12. The method in accordance with claim 11, wherein the software service comprise an executable control application in addition to the dynamically linkable library, which executable control application binds itself to the TCP/IP port and forwards the commands from the TCP/IP port to the dynamically linkable library.

13. The method in accordance with claim 1, wherein communication through the TCP/IP port is carried out under telnet protocol.

14. The method in accordance with claim 1, wherein the software service issues an event message when a predefined event occurs on the laboratory equipment.

15. The method in accordance with claim 14, wherein the software service monitors the laboratory equipment for the predefined event and/or wherein the event message is sent through the TCP/IP port.

16. A method for controlling an automated storage system for laboratory objects, wherein the storage system comprises a plurality of storage locations for receiving the laboratory objects, the method comprising:
defining users having access to the storage system and storing the users in a database;
defining partitions, with each partition comprising at least part of the storage locations, and storing the partitions in the database; and
storing properties for each of the partitions in the database.

17. The method in accordance with claim 16, wherein the properties comprise a list of users having access rights to the partition.

18. The method in accordance with claim 17, further comprising defining at least one common partition where all users have access rights.

19. A method for controlling an automated storage system for laboratory objects, wherein the storage system comprises a plurality of storage locations for receiving the laboratory objects, the method comprising:
defragmenting the objects automatically within the storage locations by rearranging and storing the objects in a physically contiguous manner.

20. The method in accordance with claim 19, wherein the storage locations are arranged in a plurality of storage towers and the objects are rearranged to free at least one storage tower from the objects.

21. The method in accordance with claim 19, further comprising accessing a database with inventory data describing used and unused storage locations.

22. An apparatus for controlling laboratory equipment, comprising:
a host computer having at least a hardware interface and a TCP/IP port, wherein the laboratory equipment is connected to the host computer via the hardware interface;
first code recorded on a tangible medium being executable on the host computer for listening to messages on the TCP/IP port;
second code recorded on a tangible medium being executable by the first code to process a command received through the TCP/IP port; and
a controller structured and arranged to control the laboratory equipment through the hardware interface in accordance with the processed command.

23. A system comprising:
a host computer having at least a hardware interface and a TCP/IP port, wherein laboratory equipment is coupled to the host computer through the hardware interface;
a server having a database containing data associated with one or more instructions for implementing control of laboratory equipment; and
at least one of a hardware and software component for processing a command received on the TCP/IP port and for controlling the laboratory equipment in accordance with the command.

24. A computer program product comprising a computer usable medium having readable program code embodied in the medium and including at least one component to:
process commands received on a TCP/IP port of a host computer coupled to laboratory equipment through a hardware interface; and
control the laboratory equipment based upon the processed commands.
